(19) United States
(12) Patent Application Publication
(10) Pub. No.: US 2012/0012346 A1
(43) Pub. Date: Jan. 19, 2012

(54) ODORANT FOR FIRE SUPPRESSION SYSTEM

(76) Inventors: Adam Chattaway, Berkshire (GB); Paul Rennie, Bracknell (GB); Josephine Gabrielle Gatsonides, Dunstable (GB); Robert Glaser, Stella, NC (US)

(21) Appl. No.: 12/835,865

(22) Filed: Jul. 14, 2010

(51) Int. Cl. A62C 3/00

(52) U.S. Cl. 169/43

(57) ABSTRACT

A method for protecting a user in an enclosed environment includes providing an enclosed environment that holds cargo that has first odor; flowing a gas to the enclosed environment; and adding an odorant having a second odor to the gas, the first odor being distinctive from the second odor such that a presence of the second odorant provides a warning that the gas is present.

### BACKGROUND OF THE INVENTION

This disclosure relates to fire suppression systems, and more particularly to the use odorants in fire suppression systems.

It is well known in the art that fire requires fuel, heat, and oxygen to propagate. Some fire suppression methodologies use inert gases to dilute the supply of oxygen in the air to suppress the spread and propagation of fire.

### SUMMARY OF THE INVENTION

According to an example embodiment, a method for protecting a user in an environment includes providing an enclosed environment that holds cargo that has first odor; flowing a gas to the enclosed environment; and adding an odorant having a second odor to the inert gas, the first odor being distinctive from the second odor such that a presence of the second odorant provides a warning that the inert gas is present.

According to another example embodiment a method for protecting a user in an enclosed environment includes; providing an enclosed environment holding cargo that has a first odor; flowing an inert gas to the enclosed environment; and adding an odorant having a second odor to the inert gas, the first odor being distinctive from the second odor such that a presence of the second odorant provides a warning that the inert gas is present and the chosen second odor does cause concern in humans adjacent the enclosed environment.

According to a still further example embodiment, a method for protecting a user in an enclosed environment includes providing an enclosed environment holding cargo that has a first odor; providing a passenger compartment adjacent the cargo area; providing a fire suppressant system, flowing an inert gas from the suppressant system to the enclosed environment; and adding an odorant having a second odor to the inert gas as the gas flows, the first odor being distinctive from the second odor such that a presence of the second odorant provides a warning that the inert gas is present and the second odor does not cause concern in humans adjacent the enclosed environment.

These and other features of the present invention can be best understood from the following specification and drawings, the following of which is a brief description.

### BRIEF DESCRIPTION OF THE DRAWINGS

FIG. 1 is a prior art depiction of an inert gas discharge pipe and a module containing an odorant.

FIG. 2 is an embodiment showing a fire suppressant system utilizing the prior art of FIG. 1.

FIG. 3 shows a method of utilizing the embodiments in FIGS. 1 and 2.

FIG. 4 shows an environment for the fire suppressant system of FIG. 2.

### DETAILED DESCRIPTION OF THE PREFERRED EMBODIMENT

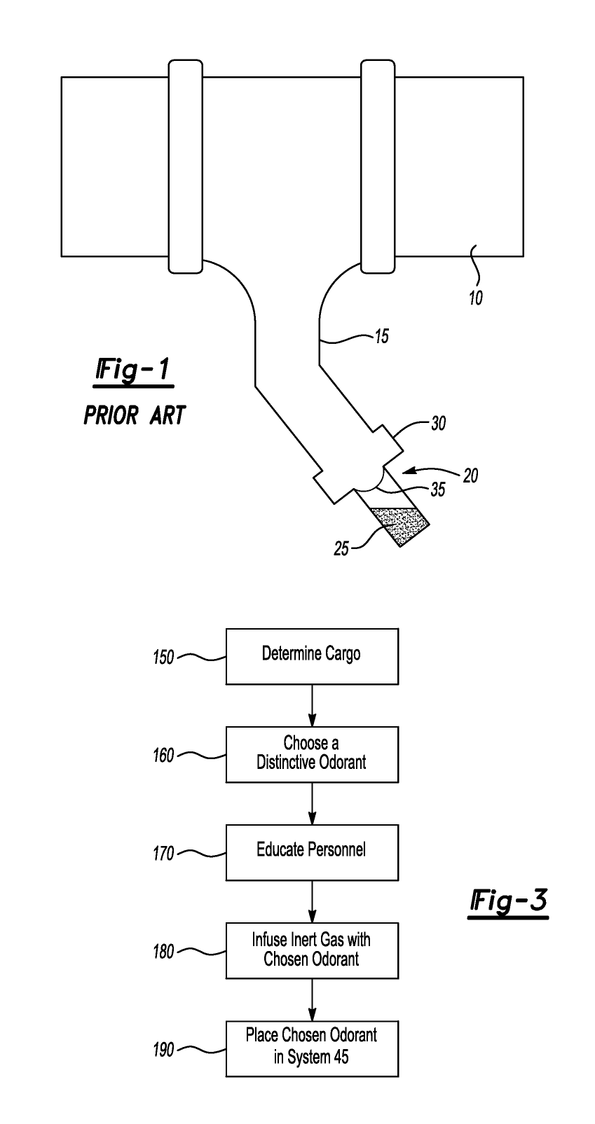

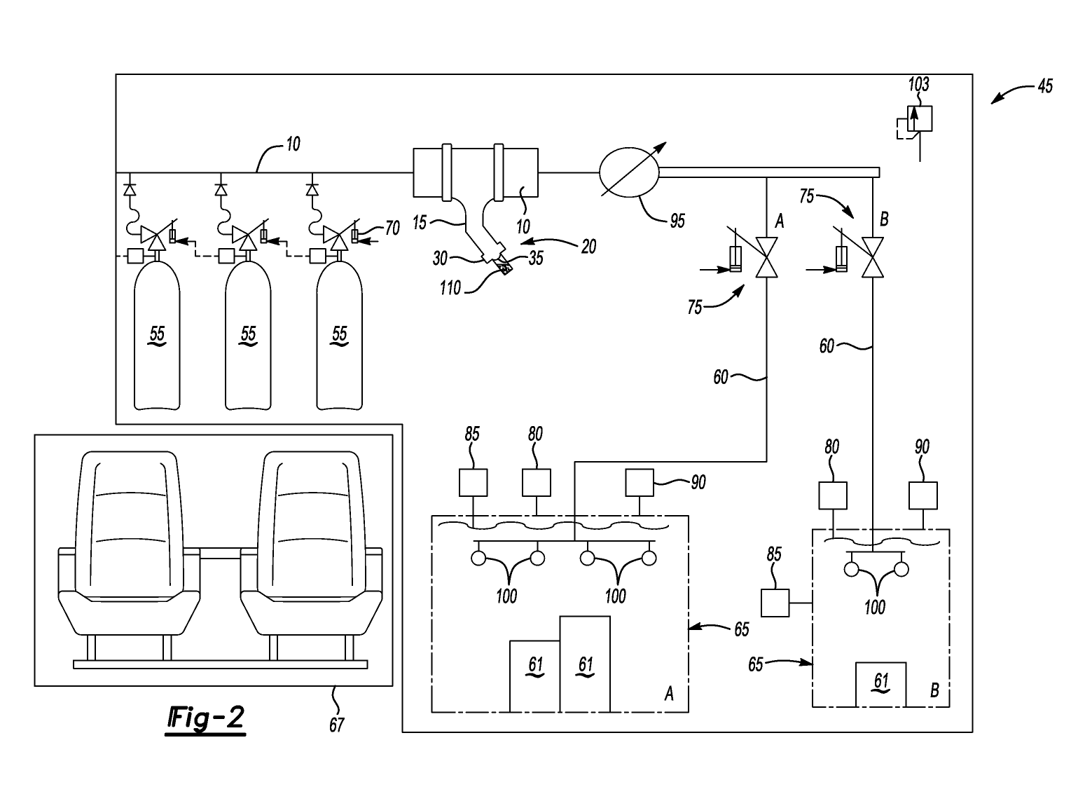

Referring now to FIG. 1, prior art conduit 10 through which a gas, which may be an inert gas such as nitrogen, helium argon or the like, flows to suppress a fire (not shown) is shown. The conduit 10 has an elbow 15 in which a module 20 containing an odorant 25 is disposed. The module 20 screws into an elbow bracket 30 to retain it there. A disc seal 35 seals the odorant 25 within the module 20 and ruptures if an inert gas flows through conduit 10. Typically, the disc seal 35 bursts at five atmospheres of pressure or more, i.e., below the pressure of the flowing inert gas, and therefore other burst pressures are anticipated herein. The odorant 25 is not placed in high pressure canisters 55 (see FIG. 2) because it stays as a liquid if stored in the inert gas canisters and therefore it is difficult to get into the inert gas flow.

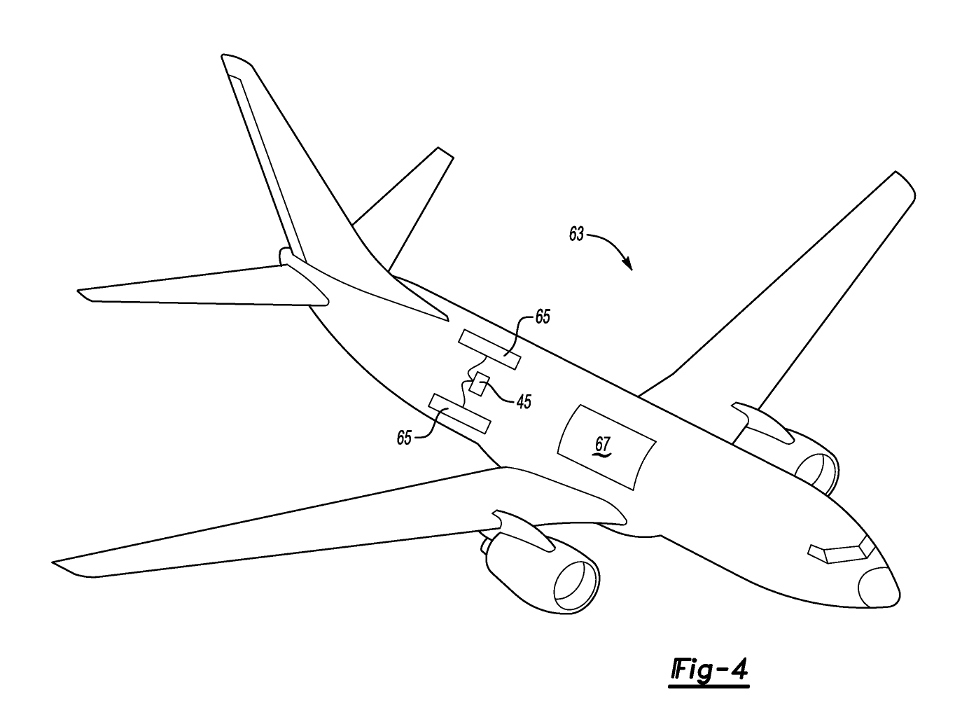

Referring now to FIG. 2, a system 45 for use in an enclosed environment 65, such as a cargo bay, is shown. Gases may accumulate in rooms or pits, and be dangerous to human health. One working in an enclosed environment, which may be enclosed, like a worker entering a cargo bay (shown schematically as 65—see also FIG. 4) may not be aware of the presence of the inert gas and a worker's health may be affected.

The system 45 includes plurality of high pressure canisters 55 that hold an inert gas are connected by conduit 10 and pipes 60 to enclosed environments 65, such as a storage or cargo bay in an aircraft 63, where fire may occur and be suppressed. In the aircraft 63 a passenger compartment 67 may be near or adjacent to an enclosed environment 65. The system 45 ports inert gas to enclosed environments 65 in the event of a fire.

Each canister 55 is attached to the conduit 10 by a discharge pressure regulator/control valve 70 and to the enclosed environment 65 by a diverter valve 75. Each enclosed environment 65 has a room pressure transducer 80, a temperature transmitter 85, and a fire detector 90 (such as a smoke detector). A control valve 95 is placed in fluid communication with the conduit 10 that prevents inert gas from flowing from the canisters 55 to the enclosed environments 65.

Typically, if a fire is detected in an enclosed environment 65, e.g., from signals from any of the room pressure transducer 80, the temperature transmitter 85, and/or the fire detector 90, a controller 103, which is conventionally in signal communication with the room pressure transducer 80, the temperature transmitter 85, and/or the fire detector 90, causes the discharge pressure regulator/control valve 70 of one or more of the canisters 55 to port inert gas through conduit 10, through open control valve 95 to the diverter valves 75. The diverter valves 75 port the inert gas downstream to the nozzles 100 in the relevant enclosed environment 65 to suppress fire therein.

The valves such as pressure regulator/control valve 70 and diverter valve 75 and or the canisters 55 may fail or leak. If a failure does occur, or if the system 45 suppresses a fire but the controller 103, for instance, fails to alert a user that there may be inert gas in the enclosed environments 65, one who might enter the enclosed environments 65 might be entering an unhealthy place.

If the regulator/control valve 70 and diverter valve 75 fail, leak or operate properly, enough pressure may be exerted on the odorant module 20 to cause the disc seal 35 to burst and gas passing through the conduit 10 acts as a venturi to pull an odorant 110 into the conduit 10 and odorize the inert gas. In an alternative embodiment, an odorant 110 may be included in the canisters 55 to be released with the gas contained therein.

By using a particular odorant 110 as discussed hereinbelow, one who enters an enclosed environment 65, in which the oxygen content in that enclosure may be at unhealthy levels, senses the odorant and vents the enclosed environment 65 and shuts off the system 45 by closing valve 95 before safely entering the enclosed environment 65.

In order to optimize the training of the worker, a recognizable odorant 110 may be used consistently within systems 45 that use inert gas for alerting workers of this unhealthy or below appropriate level of oxygen in the air.

The choice of odorant 110 should be sufficiently different from any odors that might arise from the normal range of cargo 61, or other goods in an enclosed environment 65, known to be instantly recognizable, yet at the same time it may not be an odor that might likely cause anxiety or concern if the odorant 110 entered the passenger cabin 67 atmosphere during flight. Generally, odorants 25 used in the prior art are sulfur based chemicals such as thiols or mercaptans, sulfides or similar odorant. These are foul smelling “stench agents.” This practice is so well known that the general public believes that this is in fact the odor of natural gas. Other odorants include limonene, which has a pungent, sickly, orange smell and it is very obvious. When choosing an odorant one may have the following known choices:

1 Esters

| | | Natural |
|---|---|---|
| Compound | Fragrance | occurrence |
| Methyl formate | Ethereal | |
| Methyl acetate | Sweet, nail polish | |
| | Solvent | |
| Methyl butyrate | Fruity, apple, | |
| Methyl Butanoate | Pineapple | |
| Ethyl acetate | Sweet, solvent | Wine |
| Ethyl butyrate | Fruity, orange | |
| Ethyl butanoate | Pineapple | |
| Isoamyl acetate | Fruity, banana | |
| | Pear | |
| Pentyl butyrate | Fruity, pear | |
| Pentyl butanoate | Apricot | |
| Pentyl pentanoate | Fruity, apple | |
| Octyl acetate | Fruity, orange | |
| Fructone | Fruity, apple-like | |
| Hexyl acetate | Apple, floral, fruity | |
| Ethyl | strawberry | |
| methylphenylglycidate | | |

2 Terpenes

| Compound | Fragrance | Natural occurrence |
|---|---|---|
| Myrcene | Woody, complex | Verbena, bay |
| Geraniol | Rose, flowery | Geranium, lemon |
| Nerol | Sweet rose, flowery | Neroli, lemongrass |
| Citral, lemonal | Lemon | Lemon myrtle, |
| Geranial, neral | | lemongrass |
| Citronellal | Lemon | Lemongrass |
| Citronellol | Lemon | Lemongrass, rose |
| | | Pelargonium |
| Linalool | Floral, sweet | Coriander, sweet basil |
| | Woody, lavender | Lavender |
| Merolidol | Woody, fresh bark | Neroli, ginger |
| | | Jasmine |

3 Cyclic Terpenes

| Compound | Fragrance | Natural occurrence |
|---|---|---|
| Limonene | Orange | Orange, lemon |
| Camphor | Camphor | Camphor laurel |
| Terpineol | Lilac | Lilac, cajuput |
| Alpha-lonone | Violet, woody | Violet |
| Thujone | Minty | Cypress, lilac, |
| | | Juniper |

4 Aromatic

| | | Natural |
|---|---|---|
| Compound | Fragrance | occurrence |
| Benzaldehyde | Almond | |
| Eugenol | Clove | Clove |
| Cinnamaldehyde | Cinnamon | Cassia, Cinnamon |
| Ethyl maltol | Cooked fruit | |
| | Caramelized sugar | |
| Vanillin | Vanilla | Vanilla |
| Anisole | Anise | Anise |
| Anethole | Anise | anise, Sweet basil |
| Estragole | Terragon | Terragon |
| Thymol | Thyme | Thyme |

5 Amines

| Compound | Fragrance | Natural occurrence |
|---|---|---|
| Trimethylamine | Fishy, Ammonia | |
| Putrescine | Rotting flesh | Rotting flesh |
| Diaminobutane | | |
| Cadaverine | Rotting flesh | Rotting flesh |
| Pyridine | Fishy | |
| Indole | Faecal, flowery | Faeces jasmine |
| Skatole | Faecal | Faeces |

6 Alcohols

| | | Natural |
|---|---|---|
| Compound | Fragrance | occurrence |
| Furaneol | strawberry | |
| 1-Hexanol | herbaceous, | |
| | woody | |
| Cis-3-Hexen-l-ol | Fresh cut grass | |
| Menthol | peppermint | |

7 Aldehydes

| | | Natural |
|---|---|---|
| Compound | Fragrance | occurrence |
| Acetaldehyde | ungent | |
| Hexanol | Green, grassy | |
| Cis-3-Hexen-l-ol | Green tomatoes | |
| Furfural | Burnt oats | |

8 Ketones

| | | Natural |
|---|---|---|
| Compound | Fragrance | occurrence |
| Dihydrojasmone | Fruity, woody, | |
| | floral | |
| Oct-1-en-3-one | Blood, metallic, | |
| | mushroom-like | |
| 2-Acetyl-1-pyrroline | Fresh bread, | |
| | jasmine rice | |
| 6-Acetyl-2,3,4,,5- | Fresh bread, | |
| tetrahydropyridine | tortillas, popcorn | |

9 Lactones

| Compound | Fragrance | Natural occurrence |
|---|---|---|
| Gamma- | Intense peach | |
| Decalactone | flavour | |
| Gamma- | Coconut odour, | Popular in suntan |
| Nonalactone | | lotions |
| Delta-Octalactone | Creamy note | |
| Jasmine lactone | Powerful fatty | |
| | fruity peach and | |
| | apricot | |
| Massoia lactone | Powerful creamy | |
| | coconut | |
| Wine lactone | sweet coconut odour | |
| Sotolon | Maple syrup, curry, | |
| | fenugreek | |

10 Thiols

| | | Natural |
|---|---|---|
| Compound | Fragrance | occurrence |
| Furaneol | strawberry | |
| 1-Hexanol | herbaceous, woody | |
| Cis-3-Hexen-1-ol | Fresh cut grass | |
| Menthol | peppermint | |

11 Miscellaneous Compounds

| Compound | Fragrance | Natural occurrence |
|---|---|---|
| Methylphospine & | Garlic-metallic | Two of the most |
| dimethylphosphine | | potent odorants known |
| Nerolin | | |
| Tetrahydrothiophene | | |
| 2,4,6-Trichloroanisole | | |
| Substituted | | |
| pyrazines | | |

When choosing the particular odorant 110 to use, one must be aware of the odors in the environment and/or the passenger compartment. For instance if meat is being air freighted, one may choose to avoid any of the odorants (first odors) from the amine group that smell like rotted flesh (not shown) cited hereinabove that conflict with the smell of meat (i.e., first odor). Similarly, if one is transporting flowers (not shown), an odorant (i.e., second odors) from the Terpene groups, that smell like flowers (i.e., first odors) cited hereinabove. If fruit (not shown) is being transported, an odorant (i.e., second odors) from the Ester group that smell like fruit (i.e., first odors) may be avoided. Also, an odorant may be chosen from the list above (i.e., second odor) that has the lowest possibility of matching or resembling the odors (i.e., first odor) that might normally be expected to exist in the passenger compartment and then used on a permanent basis. It should be noted that a first odor may have no distinguishable odor and be deemed ambient odor. The second odor is distinguishable from the ambient or distinguishable first odor.

In order to take advantage of the distinctive odorants described above, one may determine a type of cargo 61 carried or held in an enclosed environment 65 (step 150), choose an odorant that is not likely to alarm, cause anxiety or concern of passengers nearby the enclosed environment 65 as in an aircraft 63 and that is distinctive from a normal odor of the cargo to be carried (step 160), educate personnel who may enter the enclosed environment (step 170), insert an odorant module 20 including the chosen odorant 110 (step 180) and infuse any flowing inert gas with the chosen odorant 110 to an enclosed environment 65 (step 190) so that anyone who might enter the enclosed environment is warned of the presence of the inert gas by detecting the chosen odorant 110.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for protecting a user in an environment, said method comprising;
flowing a gas to said environment having a first odor;
adding an odorant having a second odor to said gas, said first odor being distinctive from said second odor such that a presence of said second odorant provides a warning that said gas is present.

2. The method of claim 1 wherein said second odor is chosen from a group of Esters, Terpenes, Cyclic Terpenes, Aromatics, Alcohols, Aldehydes, Ketones, or Lactones.

3. The method of claim 1 wherein said second odor is chosen from a group of Methylphospine, Dimethylphosphine, Nerolin, Tetrahydrothiophene, 2,4,6-Trichloroanisole or Substituted pyrazines.

4. The method of claim 1 further comprising educating users that a chosen second odor is a warning that gas is present.

5. The method of claim 1 further comprising inserting said odorant into a fire suppressant system.

6. The method of claim 5 wherein said fire suppressant system is in a cargo bay of an aircraft that is separate from a passenger compartment of the aircraft.

7. The method of claim 5 wherein said gas is an inert gas.

8. A method for protecting a user in an enclosed environment, said method comprising;
flowing an inert gas to an enclosed environment having a first odor;
adding an odorant having a second odor to said inert gas, said first odor being distinctive from said second odor such that a presence of said second odorant provides a warning that said inert gas is present and said second odor does not cause concern in humans adjacent said enclosed environment.

9. The method of claim 8 wherein said second odor is chosen from a group of Esters, Terpenes, Cyclic Terpenes, Aromatics, Alcohols, Aldehydes, Ketones, or Lactones.

10. The method of claim 8 wherein said second odor is chosen from a group of Methylphospine, Dimethylphosphine, Nerolin, Tetrahydrothiophene, 2,4,6-Trichloroanisole or Substituted pyrazines.

11. The method of claim 8 further comprising educating users that a chosen second odor is a warning that inert gas is present.

12. The method of claim 8 further comprising inserting said odorant into a fire suppressant system

13. The method of claim 12 wherein said fire suppressant system is in a cargo bay of an aircraft that is adjacent to a passenger compartment of said aircraft.

14. A method for protecting a user in an enclosed environment, said method comprising;
providing an enclosed environment holding cargo having a first odor;
providing a passenger compartment adjacent said cargo area;
providing a fire suppressant system,
flowing an inert gas from said suppressant system to said enclosed environment;
adding an odorant having a second odor to said inert gas, said first odor being distinctive from said second odor such that a presence of said second odorant provides a warning that said inert gas is present and said second odor does not cause concern in humans adjacent said enclosed environment.

15. The method of claim 14 wherein said second odor is chosen from a group of Esters, Terpenes, Cyclic Terpenes, Aromatics, Amines, Alcohols, Aldehydes, Ketones, Lactones, or Thiols.

16. The method of claim 14 wherein said second odor is chosen from a group of Methylphospine, Dimethylphosphine, Nerolin, Tetrahydrothiophene, 2,4,6-Trichloroanisole or Substituted pyrazines.

17. The method of claim 14 further comprising educating users that a chosen second odor is a warning that inert gas is present.

18. The method of claim 14 further comprising inserting said odorant into a fire suppressant system.

19. The method of claim 18 wherein said fire suppressant system is in an aircraft.

20. The method of claim 14 wherein said gas is an inert gas.
